(19) United States
(12) Patent Application Publication
(10) Pub. No.: US 2018/0292707 A1
(43) Pub. Date: Oct. 11, 2018

(54) DISPLAY PANEL AND MANUFACTURING METHOD THEREOF

(71) Applicant: Shenzhen China Star Optoelectronics Technology Co., Ltd., Shenzhen City (CN)

(72) Inventors: Lixuan Chen, Shenzhen City (CN); Yungjui Lee, Shenzhen City (CN)

(21) Appl. No.: 15/112,189

(22) PCT Filed: May 23, 2016
(86) PCT No.: PCT/CN2016/083059

§ 371 Date: Jul. 17, 2016

(30) Foreign Application Priority Data
May 9, 2016 (CN) 2016103044424

(51) Int. Cl. G02F 1/1335; G02B 5/30

(52) U.S. Cl. CPC G02F 1/133528; G02F 2001/133548; G02F 1/133512; G02B 5/3058

(57) ABSTRACT

The present invention provides a display panel and a manufacturing method thereof. The display panel of the present invention includes an upper substrate and a lower substrate opposite to each other, a wire-grid polarizer, and a black matrix. The wire-grid polarizer includes multiple wire-grid units that are arranged and jointed in a rectangular array and orthogonal projections of gaps between the wire-grid units are cast on and within the black matrix so that the black matrix may shield and cover the gaps between the wire-grid units of the wire-grid polarizer to thereby reduce, to a great extent, influences on a large-sized display panel resulting from poor jointing and gaps present in a jointed structure of a polarizer.

### BACKGROUND OF THE INVENTION

### 1. Field of the Invention

The present invention relates to the field of liquid crystal display technology, and in particular to a display panel and a manufacturing method thereof.

### 2. The Related Arts

Nano-imprint lithography (NIL) provides a breakthrough of the difficult of the traditional photolithography in reducing feature size and offers advantages of high resolution, low cost, and high throughput. Since 1995, nano-imprint lithography has evolved and diversified into various imprint techniques, which are widely used in various fields including semiconductor manufacture, micro-electro-mechanical system (MEMS), biochips, and biomedicine. The essence of the NIL technology is that a mold plate is used to transfer a pattern to a backing and the medium used for the transfer is a polymer film that is extremely thin so that measures, such as hot pressing or radiation, can be used to have the structure cured and hardened to preserve the transferred pattern. The entire process includes two processes of imprinting and pattern transferring. According to the difference of the imprinting process, NIL can be classified in three photolithographic techniques, including hot embossing, ultraviolet (UV) curing, and micro contact printing (μCP).

Various devices, such as liquid crystal displays (LCDs) and organic light-emitting diodes (OLEDs), necessarily involve polarizers. A traditional polarizer is generally composed of multiple layers of films, among which a core component is a polarization layer, which is often a polyvinyl alcohol (PVA) layer that comprises iodine molecule exhibiting an optical polarization effect. The next are protection layers, which are located on opposite sides of the polarization layer and are generally triacetyl cellulose (TAC) layers that are transparent for maintaining the polarization elements of the polarization layer in a stretched condition and preventing loss of moisture from the polarization element and protecting against external influence. The polarizer uses the absorption effect of the dichroic iodine molecules to generate polarized light.

With the progress of the NIL technology, attempts have been made in making metallic wire grid structures to provide a polarization effect for light within the wavelength range of visible light. Since the metallic wire grid structure absorbs only a small amount of light, one polarized component of natural light in one direction is reflected and one polarized component in another direction is allowed to pass, and thus, the reflected light can be recycled and reused through polarization rotation, providing extreme potential in liquid crystal displays. However, limitations of the mold plate that are currently used in the NIL technology prevent most of them from matching the sizes of television display panels. Making a NIL polarizer of 21 inches and larger sizes requires the formation of a huge mold plate or alternatively, small mold plates must be puzzled up together in order to conduct desired NIL operations. The former is costly and the operation is complicated and difficult, while the later may render undesired situations in jointing the mold plates, such as poor jointing or gaps.

### SUMMARY OF THE INVENTION

An object of the present invention is to provide a display panel, which allows for jointing a plurality of wire-grid units to form a large-sized wire-grid polarizer with a black matrix covering jointing gaps between the wire-grid units of the wire-grid polarizer for reducing influence resulting from poor jointing.

Another object of the present invention is to provide a manufacturing method of a display panel, in which a plurality of wire-grid units is jointed together to form a large-sized wire-grid polarizer with a black matrix covering jointing gaps between the plurality of wire-grid units of the wire-grid polarizer for reducing influence resulting from poor jointing.

To achieve the above objects, the present invention provides a display panel, which comprises an upper substrate and a lower substrate that are arranged opposite to each other, a wire-grid polarizer, and a black matrix, the black matrix being arranged on a side of the upper substrate or a side of the lower substrate, the wire-grid polarizer being arranged on a side of the upper substrate or a side of the lower substrate; wherein the wire-grid polarizer comprises a plurality of wire-grid units that is arranged and jointed in a rectangular array and gaps between the wire-grid units are located on and within the black matrix.

The wire-grid units are each formed with a 6-8 inch imprint mold plate unit.

The plurality of wire-grid units of the wire-grid polarizer is formed, in a successive manner, with a single imprint mold plate unit.

The plurality of wire-grid units of the wire-grid polarizer is formed, simultaneously, with a jointed imprint mold plate formed by jointing a plurality of imprint mold plate units.

The black matrix comprises a plurality of light-shielding strips extending in different directions and intersecting each other, and the light-shielding strips have a width that is at least 20 μm.

The present invention also provides a manufacturing method of a display panel, which comprises the following steps:

(1) providing a panel to be treated, which comprises a polarizer to be imprinted, an upper substrate and a lower substrate opposite to each other, and a black matrix, the black matrix being arranged on a side of the upper substrate or a side of the lower substrate;

(2) providing one or more imprint mold plate units and using the one or more imprint mold plate units to form a plurality of wire-grid units that is arranged and jointed in a rectangular array on the polarizer to be imprinted so as to obtain a wire-grid polarizer, wherein each of the wire-grid units is formed with one of the one or more imprint mold plate units corresponding thereto; and

(3) forming a display panel such that the wire-grid polarizer is arranged on a side of the upper substrate or a side of the lower substrate and projections of gaps between the wire-grid units are located on and within the black matrix.

In step (2), one single imprint mold plate unit is provided and the imprint mold plate unit is movable to successively and sequentially form the plurality of wire-grid units on the polarizer to be imprinted.

In step (2), a plurality of imprint mold plate units is provided to respectively correspond to the plurality of wire-grid units of the wire-grid polarizer and is jointed together to form a jointed imprint mold plate so that the imprint mold plate is used in a one-time imprinting operation to form the plurality of wire-grid units on the polarizer to be imprinted.

In step (2), the one or more imprint mold plate units provided are each a 6-8 inch imprint mold plate unit.

The black matrix comprises a plurality of light-shielding strips extending in different directions and intersecting each other and the light-shielding strips have a width that is at least 20 μm.

The present invention also provides a display panel, which comprises an upper substrate and a lower substrate that are arranged opposite to each other, a wire-grid polarizer, and a black matrix, the black matrix being arranged on a side of the upper substrate or a side of the lower substrate, the wire-grid polarizer being arranged on a side of the upper substrate or a side of the lower substrate;

wherein the wire-grid polarizer comprises a plurality of wire-grid units that is arranged and jointed in a rectangular array and gaps between the wire-grid units are located on and within the black matrix;

wherein the wire-grid units are each formed with a 6-8 inch imprint mold plate unit; and

wherein the black matrix comprises a plurality of light-shielding strips extending in different directions and intersecting each other and the light-shielding strips have a width that is at least 20 μm.

The efficacy of the present invention is that the present invention provides a display panel, which comprises upper and lower substrates opposite to each other, a wire-grid polarizer, and a black matrix. The wire-grid polarizer comprises a plurality of wire-grid units that is arranged and jointed in a rectangular array and orthogonal projections of gaps between the wire-grid units are cast on and within the black matrix so that the black matrix may shield and cover the gaps between the wire-grid units of the wire-grid polarizer to thereby reduce, to a great extent, influences on a large-sized display panel resulting from poor jointing and gaps present in a jointed structure of a polarizer. The present invention provides a manufacturing method of a display panel, in which one or more nano-imprint mold plates are used to manufacture a wire-grid polarizer having a jointed structure so that a wire grid of the wire-grid polarizer is formed of a plurality of wire-grid units arranged and jointed in the form of a rectangular array and a black matrix is used to shield and cover gaps between the plurality of wire-grid units of the wire-grid polarizer so as to reduce, to a great extent, influences on a large-sized display panel resulting from poor jointing and gaps present in a jointed structure of a polarizer.

### BRIEF DESCRIPTION OF THE DRAWINGS

The technical solution, as well as other beneficial advantages, of the present invention will be apparent from the following detailed description of embodiments of the present invention, with reference to the attached drawing.

In the drawing:

FIG. 1 is a schematic view illustrating the structure of a display panel according to the present invention;

FIG. 2 is a flow chart illustrating a manufacturing method of a display panel according to the present invention; and

FIG. 3 is a schematic view illustrating step 2 of the manufacturing method of the display panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

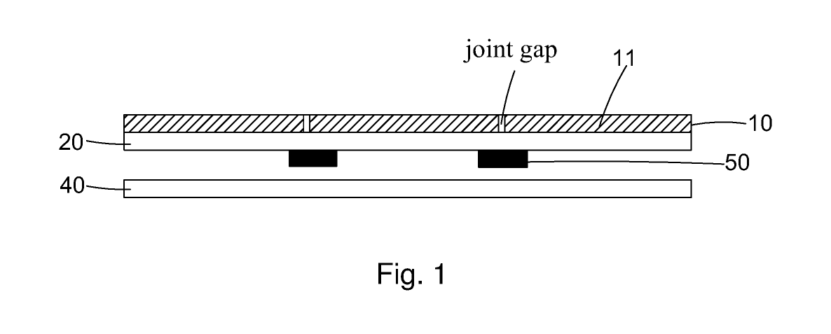

Referring to FIG. 1, the present invention provides a display panel, which comprises an upper substrate 20 and a lower substrate 40 that are arranged opposite to each other, a wire-grid polarizer 10, and a black matrix 50. The wire-grid polarizer 10 comprises a plurality of wire-grid units 11 that is arranged and jointed in the form of a rectangular array. Gaps between the wire-grid units 11 are arranged to cast orthogonal projections that are located in the black matrix 50.

In the instant embodiment, the upper substrate 20 is a color filter substrate and the lower substrate 40 is a thin-film transistor (TFT) array substrate. The black matrix 50 is arranged on a side of the upper substrate 20 that is adjacent to the lower substrate 40. The wire-grid polarizer 10 is externally arranged and positioned on a side of the upper substrate 20 that is distant from the lower substrate 40.

Specifically, the wire-grid units 11 are respectively formed of imprint mold plate units corresponding thereto so that the imprint mold plate units are not necessarily made in huge sizes and even an existing 6-8 inch mold plate can be used.

Specifically, the plurality of wire-grid units 11 of the wire-grid polarizer 10 is formed, in a successive manner, with a single imprint mold plate unit 71, or alternatively, the plurality of wire-grid units 11 of the wire-grid polarizer 10 is formed, in a simultaneous manner, with a jointed imprint mold plate that is formed by jointing a plurality of imprint mold plate units 71.

Specifically, the black matrix 50 comprises a plurality of light-shielding strips extending in different directions and intersecting each other. The projections of the gaps between the wire-grid units 11 are located on and within the light-shielding strips of the black matrix 50. The light-shielding strips have a width that is at least 20 μm that is sufficient to shield the gaps between the wire-grid units 11 of the wire-grid polarizer 10.

As an optional embodiment, the display panel of the present invention may adopt the so-called BOA (Black matrix On Arry) technology, where the black matrix 50 is arranged on the lower substrate 40 that serves as a TFT array substrate and the wire-grid polarizer 10 is internally arranged and positioned on a side of the lower substrate 40 that is adjacent to the upper substrate 2, the remaining parts being identical to those of the previous embodiment of the present invention so that repeated description will be omitted.

The display panel according to the present invention is structured such that a black matrix 50 is used to shield and cover gaps between wire-grid units 11 of a wire-grid polarizer 10 so as to reduce, to a great extent, influences on a large-sized display panel resulting from poor jointing and gaps present in a jointed structure of a polarizer, thereby allows a wire-grid polarizer that is formed with a jointed structure having a large size and manufactured with a nanoimprint operation to be used in display panels, and the manufacturing operation is made simple.

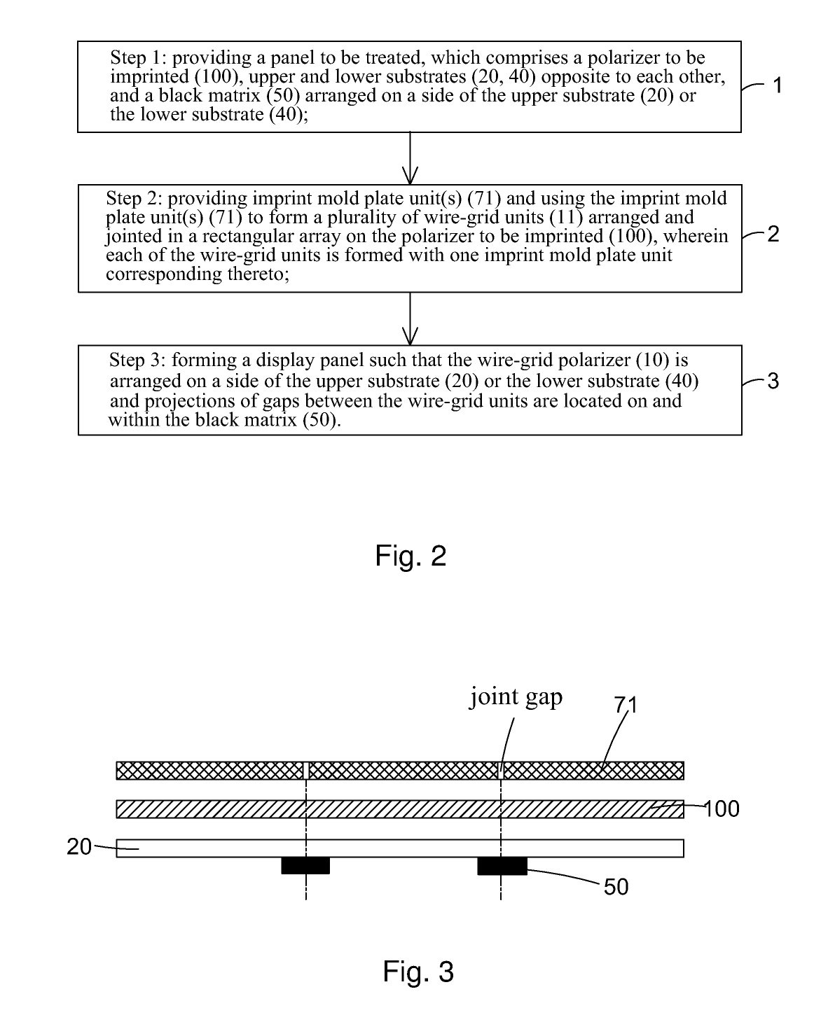

Referring to FIG. 2, the present invention also provides a manufacturing method of a display panel, which comprises the following steps:

Step 1: providing a panel to be treated, which comprises a polarizer to be imprinted 100, upper and lower substrates 20, 40 that are arranged opposite to each other, and a black matrix 50.

Specifically, the black matrix 50 comprises a plurality of light-shielding strips extending in different directions and intersecting each other. The light-shielding strips have a width that is at least 20 μm.

Specifically, the black matrix 50 is arranged on a side of the upper substrate 20 or a side of the lower substrate 40. Preferably, the black matrix 50 is arranged on a side of the upper substrate 20 that is adjacent to the lower substrate 40 or a side of the lower substrate 40 that is adjacent to the upper substrate 20.

Step 2: providing imprint mold plate unit(s) 71 and using the imprint mold plate unit(s) 71 to form a plurality of wire-grid units 11 that is arranged and jointed in the form of a rectangular array on the polarizer to be imprinted 100 so as to form a wire-grid polarizer 10, wherein each of the wire-grid units 11 is formed with a corresponding one of the imprint mold plate units.

Specifically, in Step 2, one single imprint mold plate unit 71 is provided and the imprint mold plate unit is movable to successively and sequentially form each of a plurality of wire-grid units 11 on the polarizer to be imprinted.

Or alternatively, as shown in FIG. 3, in Step 2, a plurality of imprint mold plate units 71 is provided to respectively correspond a plurality of wire-grid units 11 to be formed on the wire-grid polarizer 10 and is arranged and jointed to form a jointed imprint mold plate so that the jointed imprint mold plate is applicable to conducting a one-time imprinting operation for forming simultaneously a plurality of wire-grid units 11 on the polarizer to be imprinted.

Specifically, the imprint mold plate units 71 provided in Step 2 are 6-8 inch imprint mold plate units.

Step 3: forming a display panel, wherein the wire-grid polarizer 10 is arranged on a side of the upper substrate 20 or a side of the lower substrate 40 and projections of gaps between the wire-grid units 11 are cast on and within the black matrix 50.

Preferably, the wire-grid polarizer 10 is arranged on a side of the upper substrate 20 that is distant from the lower substrate 40 or a side of the lower substrate 40 that is distant from the upper substrate 20.

In summary, the present invention provides a display panel, which comprises upper and lower substrates opposite to each other, a wire-grid polarizer, and a black matrix. The wire-grid polarizer comprises a plurality of wire-grid units that is arranged and jointed in a rectangular array and orthogonal projections of gaps between the wire-grid units are cast on and within the black matrix so that the black matrix may shield and cover the gaps between the wire-grid units of the wire-grid polarizer to thereby reduce, to a great extent, influences on a large-sized display panel resulting from poor jointing and gaps present in a jointed structure of a polarizer. The present invention provides a manufacturing method of a display panel, in which one or more nano-imprint mold plates are used to manufacture a wire-grid polarizer having a jointed structure so that a wire grid of the wire-grid polarizer is formed of a plurality of wire-grid units arranged and jointed in the form of a rectangular array and a black matrix is used to shield and cover gaps between the plurality of wire-grid units of the wire-grid polarizer so as to reduce, to a great extent, influences on a large-sized display panel resulting from poor jointing and gaps present in a jointed structure of a polarizer.

Based on the description given above, those having ordinary skills of the art may easily contemplate various changes and modifications of the technical solution and technical ideas of the present invention and all these changes and modifications are considered within the protection scope defined by the claims of the present invention.

What is claimed is:

1. A display panel, comprising an upper substrate and a lower substrate that are arranged opposite to each other, a wire-grid polarizer, and a black matrix, the black matrix being arranged on a side of the upper substrate or a side of the lower substrate, the wire-grid polarizer being arranged on a side of the upper substrate or a side of the lower substrate;
wherein the wire-grid polarizer comprises a plurality of wire-grid units that is arranged and jointed in a rectangular array and gaps between the wire-grid units are located on and within the black matrix.

2. The display panel as claimed in claim 1, wherein the wire-grid units are each formed with a 6-8 inch imprint mold plate unit.

3. The display panel as claimed in claim 1, wherein the plurality of wire-grid units of the wire-grid polarizer is formed, in a successive manner, with a single imprint mold plate unit.

4. The display panel as claimed in claim 1, wherein the plurality of wire-grid units of the wire-grid polarizer is formed, simultaneously, with a jointed imprint mold plate formed by jointing a plurality of imprint mold plate units.

5. The display panel as claimed in claim 1, wherein the black matrix comprises a plurality of light-shielding strips extending in different directions and intersecting each other and the light-shielding strips have a width that is at least 20 μm.

6. A manufacturing method of a display panel, comprising the following steps:
(1) providing a panel to be treated, which comprises a polarizer to be imprinted, an upper substrate and a lower substrate opposite to each other, and a black matrix, the black matrix being arranged on a side of the upper substrate or a side of the lower substrate;
(2) providing one or more imprint mold plate units and using the one or more imprint mold plate units to form a plurality of wire-grid units that is arranged and jointed in a rectangular array on the polarizer to be imprinted so as to obtain a wire-grid polarizer, wherein each of the wire-grid units is formed with one of the one or more imprint mold plate units corresponding thereto; and
(3) forming a display panel such that the wire-grid polarizer is arranged on a side of the upper substrate or a side of the lower substrate and projections of gaps between the wire-grid units are located on and within the black matrix.

7. The manufacturing method of the display panel as claimed in claim 6, wherein in step (2), one single imprint mold plate unit is provided and the imprint mold plate unit is movable to successively and sequentially form the plurality of wire-grid units on the polarizer to be imprinted.

8. The manufacturing method of the display panel as claimed in claim 6, wherein in step (2), a plurality of imprint mold plate units is provided to respectively correspond to the plurality of wire-grid units of the wire-grid polarizer and is jointed together to form a jointed imprint mold plate so that the imprint mold plate is used in a one-time imprinting operation to form the plurality of wire-grid units on the polarizer to be imprinted.

9. The manufacturing method of the display panel as claimed in claim 6, wherein in step (2), the one or more imprint mold plate units provided are each a 6-8 inch imprint mold plate unit.

10. The manufacturing method of the display panel as claimed in claim 6, wherein the black matrix comprises a plurality of light-shielding strips extending in different directions and intersecting each other and the light-shielding strips have a width that is at least 20 μm.

11. A display panel, comprising an upper substrate and a lower substrate that are arranged opposite to each other, a wire-grid polarizer, and a black matrix, the black matrix being arranged on a side of the upper substrate or a side of the lower substrate, the wire-grid polarizer being arranged on a side of the upper substrate or a side of the lower substrate;
wherein the wire-grid polarizer comprises a plurality of wire-grid units that is arranged and jointed in a rectangular array and gaps between the wire-grid units are located on and within the black matrix;
wherein the wire-grid units are each formed with a 6-8 inch imprint mold plate unit; and
wherein the black matrix comprises a plurality of light-shielding strips extending in different directions and intersecting each other and the light-shielding strips have a width that is at least 20 μm.

12. The display panel as claimed in claim 11, wherein the plurality of wire-grid units of the wire-grid polarizer are formed, in a successive manner, with a single imprint mold plate unit.

13. The display panel as claimed in claim 11, wherein the plurality of wire-grid units of the wire-grid polarizer are formed, simultaneously, with a jointed imprint mold plate formed by jointing a plurality of imprint mold plate units.
